(19) United States
(12) Patent Application Publication
(10) Pub. No.: US 2024/0210892 A1
(43) Pub. Date: Jun. 27, 2024

(54) DEVICE FOR OPENING A WATCH CASE INCLUDING A BACK FIXED TO A MIDDLE BY INTERLOCKING

(71) Applicant: Omega SA, Biel/Bienne (CH)

(72) Inventor: Christophe HEUSLER, Evilard (CH)

(73) Assignee: Omega SA, Biel/Bienne (CH)

(21) Appl. No.: 18/515,532

(22) Filed: Nov. 21, 2023

(30) Foreign Application Priority Data
Dec. 21, 2022 (EP) 22215599.6

(51) Int. Cl. G04D 1/10

(52) U.S. Cl. CPC G04D 1/10

(57) ABSTRACT

A device for opening a watch case including a back fixed to a middle by interlocking, including a fitting fixed to a frame and intended to hold a watch case in position, at least one carriage movable in translation relative to the frame in a direction X, the carriage including a tool holder to which a knife is fixed, the device further includes a control element designed to be actuated by a user, kinematically connected to the carriage with a transmission member configured so that when the control element is actuated, the carriage is translated towards the fitting or in a direction opposite to the fitting.

### TECHNICAL FIELD OF THE INVENTION

The invention relates to tooling in the microtechnology sector, particularly in the watchmaking sector.

More particularly, the invention relates to a device for opening a watch case including a back fixed to a middle by interlocking.

### TECHNOLOGICAL BACKGROUND

There is a large number of situations wherein it is necessary to open the case of a watch, for example, during the watch assembly process, in particular in order to adjust the watch movement or to clean the inside of the case, or after carrying out water-resistance tests. Of course, it is also necessary to open the case of a watch during after-sales service operations.

This opening is made by removing the back from the middle. There are several ways of fixing a back to a middle, such as screwed backs, backs fixed by a bayonet connection, interlocked backs, etc.

In the case of backs fixed to the middle by interlocking, the back includes a cavity on its periphery designed to receive the tip of a tool for removing the back from the middle. In particular, after engaging the tip of the tool in the cavity, the watchmaker uses the tool to pry the back away from the middle by pressing on the middle.

This operation is relatively delicate and requires great care on the part of the watchmaker responsible for carrying out such operation. In particular, the tool runs the risk of damaging, or at least marking, the back or middle if it is accidentally drawn into an uncontrolled movement.

When they are marked or damaged, the back or middle are either polished or replaced, at a cost that obviously cannot be borne by the owner of the watch.

The purpose of this invention is to provide a tool for opening a watch case, in particular for separating a back from a middle of a watch, simply and quickly, without risking damaging the back or the middle.

### SUMMARY OF THE INVENTION

The invention resolves the aforementioned disadvantages and, to this end, relates to a device for opening a watch case including a back fixed to a middle by interlocking. The device comprises a fitting fixed to a frame and intended to hold a watch case in position, at least one carriage movable in translation relative to the frame in a direction X. The carriage includes a tool holder to which a knife is fixed. The device further includes a control element designed to be actuated by a user, kinematically connected to the carriage by means of a transmission member configured so that when the control element is actuated, the carriage is translated towards the fitting or in a direction opposite to the fitting.

In particular embodiments, the invention may further include one or more of the following features, taken alone or in any technically possible combination.

In particular embodiments, the device comprises two carriages movable in translation with respect to the frame in the direction X, on either side of the fitting, the transmission member being configured so that when the control element is actuated, the carriages are translated in opposite directions.

In particular embodiments, the device comprises a module for adjusting the minimum distance between the two tool holders, configured so as to be able to modify the amplitude of the stroke of each of the carriages.

In particular embodiments, the module for adjusting the minimum distance between the two tool holders includes two stops each arranged between one of the tool holders and the fitting, and a positioning shaft to which an operating member is fixed, said positioning shaft cooperating by helical connection with each of the stops by means of threaded portions of opposite directions.

In particular embodiments, the fitting comprises a module for adjusting its linear position configured to translate the fitting in a direction Z orthogonal to the direction X.

In particular embodiments, the module for adjusting the linear position of the fitting is formed by a fitting body arranged so as to be movable in translation in a structure of the fitting, the fitting body including a threaded portion cooperating with an operating member in a helical connection.

In particular embodiments, the fitting can be rotated about a direction Z orthogonal to the direction X and comprises a module for adjusting its angular position configured so as to release the fitting in rotation about the direction Z or to immobilise the fitting in rotation.

In particular embodiments, the module for adjusting the angular position of the fitting includes an indexing member adapted to block the fitting in a reference angular position.

In particular embodiments, the module for adjusting the angular position of the fitting includes a ring housed in a cavity of the fitting, said ring being intended to hold the watch case in position and being movable in translation about the direction Z and being immobilised in translation by a blocking element.

In particular embodiments, the module for adjusting the angular position of the fitting includes an elastic positioning member fixed to the fitting, designed to work in compression and designed to cooperate with a cavity of the ring when the ring reaches the reference angular position.

In particular embodiments, at least the carriage includes a module for adjusting the position of the knife which it carries, said adjustment module being configured to move the knife relative to the carriage in at least one direction parallel to direction X.

In particular embodiments, the transmission member includes a cam integral in rotation with the control element, said cam comprising two cam tracks with each of which a follower cooperates, said followers being fixed respectively to each of the carriages.

In particular embodiments, the two cam tracks are symmetrical to each other with a symmetry whose centre is aligned with the axis of rotation of the cam.

In particular embodiments, the device comprises a module for adjusting the angular position of the control element relative to the frame about a direction Y orthogonal to the direction X.

In particular embodiments, the cam is kinematically connected to the control element via the module for adjusting the angular position of the control element.

In particular embodiments, the module for adjusting the angular position of the control element includes an indexing wheel integral in rotation with the cam and an indexing element adapted to cooperate with the indexing wheel in one of several angular positions so as to make the control element and the indexing wheel integral in rotation.

In particular embodiments, the frame includes two flanges arranged on either side of the fitting, said flanges including openings through which extend translational guide rods included in one of the carriages, referred to as the “first carriage”, the tool holder of the first carriage being integral in translation with the guide rods.

In particular embodiments, one of the carriages, referred to as the “second carriage”, is configured so as to be slidably guided by the guide rods.

### BRIEF DESCRIPTION OF THE FIGURES

Other features and advantages of the invention will become apparent from the following detailed description, which is given by way of example and in a non-limiting manner, with reference to the appended drawings wherein:

FIG. 1 shows a perspective view of a device for opening a watch case according to a preferred exemplary embodiment of the invention;

FIG. 2 shows another perspective view of the device of FIG. 1;

FIG. 3 shows a sectional view of the device of FIG. 1 along sectional plane A;

FIG. 4 shows a side view of the device of FIG. 1;

FIG. 5 shows a sectional view of the device of FIG. 1 along sectional plane B.

### DETAILED DESCRIPTION OF THE INVENTION

The present invention relates to a device 10 for opening a watch case, in particular a case comprising a back assembled to a middle by interlocking. In a manner known to the person skilled in the art, this back includes a cavity on its periphery intended to receive the tip of a tool, in particular a knife.

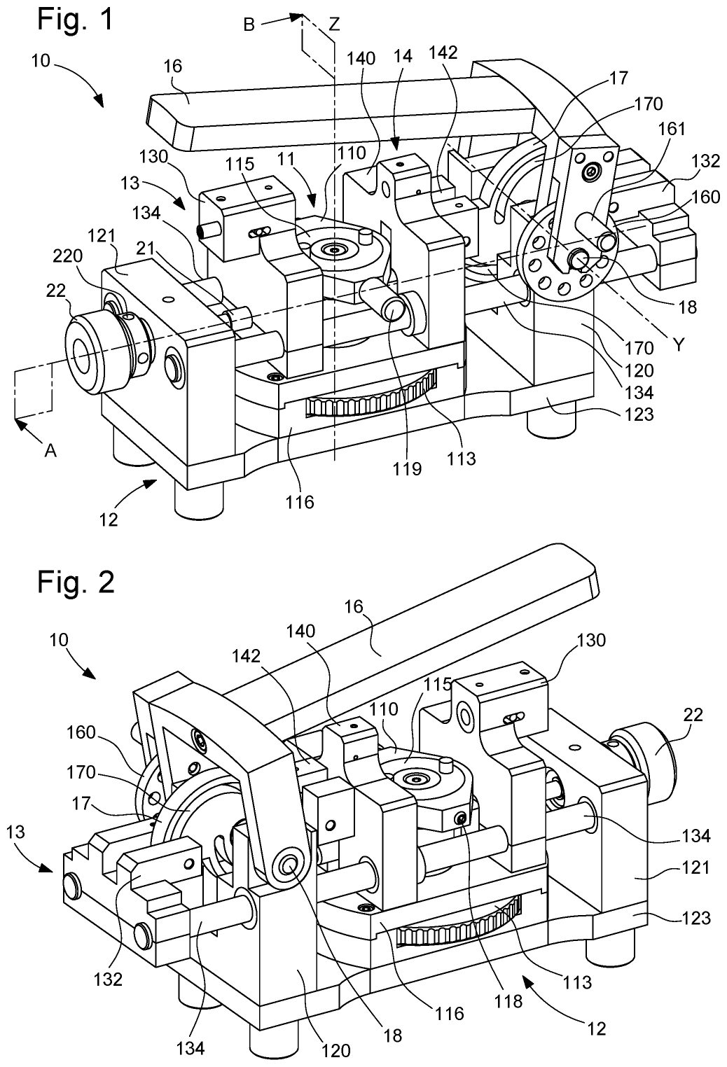

As shown in FIGS. 1 to 5, in a preferred exemplary embodiment of the invention, the device 10 includes a fitting 11 intended to hold the case in position so that it can be opened by separating the back from the middle, as described in detail below.

The device 10 includes a frame 12 to which the fitting 11 is fixed and at least one carriage 13 or 14 movable in translation relative to the frame 12 in a direction X along which the fitting 11 is arranged. The carriage 13 or 14 includes a tool holder 130 or 140 to which is fixed a knife, the free end of which is intended to be introduced into the cavity of the back of the watch immobilised by the fitting 11 in order to open the watch case.

The device 10 further includes a control element 16 designed to be actuated by a user. As described in more detail below, the control element 16 is kinematically connected to the carriage 13 or 14 via a transmission member configured so that when the control element 16 is actuated, the carriage 13 or 14 is translated towards the fitting 11 or in a direction opposite to the fitting 11 depending on the direction wherein the control element 16 is actuated.

It goes without saying that the embodiment of the invention wherein the device 10 includes a single carriage 13 or 14 is particularly suitable for watch backs including a single cavity intended to receive the knife.

In the embodiment of the invention described in the following text and illustrated in the figures, the device 10 includes two carriages 13 and 14. It is therefore intended in particular to open cases whose back includes two cavities on its periphery. Of course, the elements described below, except those relating to the second carriage 13 or 14 or in connection with the latter, are common to both embodiments of the invention.

As can be seen from the figures, the two carriages 13 and 14 can move in translation relative to the frame 12 in the direction X, on either side of the fitting 11. In other words, in a reference frame related to the fitting 11, the carriages 13 and 14 are diametrically opposite each other. It goes without saying that, in this exemplary embodiment of the invention, the cavities in the back are also diametrically opposite each other. The transmission member is configured so that when the control element 16 is actuated, the carriages 13 and 14 are translated in opposite directions. In this way, the knives carried by the tool holders 130 and 140 are inserted simultaneously into their respective cavities and exert opposing forces of equal intensity on the case.

In the preferred exemplary embodiment of the invention, the control element 16 is formed by a lever designed to be pivoted by a user so as to move the tool holders 130 and 140 towards or away from each other.

Alternatively, it can be considered that the control element 16 is formed by any gripping member capable of being rotated and/or translated by a user.

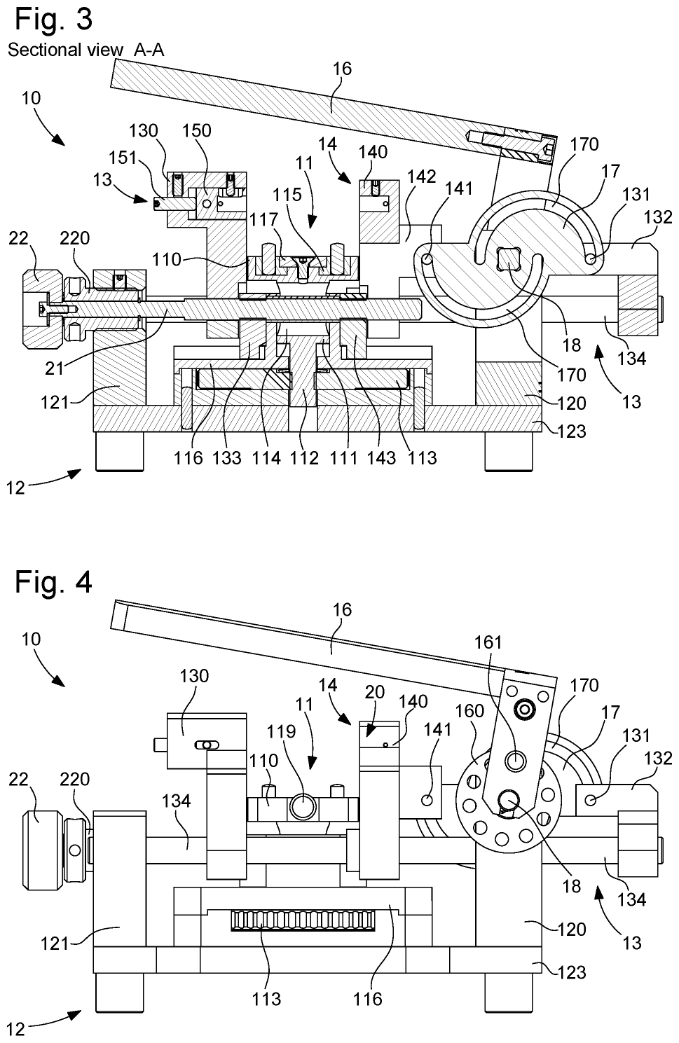

Preferably, the transmission member includes a cam 17 integral in rotation with the control element 16. Preferably, the axis of rotation of the control element 16 and that of the cam 17 are coincident. These axes are designated in FIG. 1 by the direction Y, this direction being orthogonal to the direction X. As can be seen in the cross-section of FIG. 3, the cam 17 is fixed to a transmission shaft 18 with which it is integral in rotation, in this case thanks to a square section of the transmission shaft 18 and of an opening in the cam 17 wherein it is engaged. Of course, the transmission shaft 18 and the cam 17 can be prevented from rotating by any appropriate means, such as a pin, a key, a section of the transmission shaft 18 and the cam 17 opening of complementary polygonal shapes, etc.

The cam 17 comprises two cam tracks 170 with each of which a follower 131 or 141 cooperates, said followers 131 and 141 being respectively fixed to each of the carriages 13 and 14. In the preferred exemplary embodiment, each cam track 17 is formed by a through opening extending in a curvilinear direction, here in a direction conforming to an arc of a semicircle, as shown in FIG. 3.

For the carriages 13 and 14 to move at identical speeds, the cam tracks 17 are symmetrical to each other according to a symmetry, the centre of which is aligned with the axis of rotation of the cam 17. This symmetry can be seen in FIG. 3.

The followers 131 and 141 are preferably in the form of fingers, as shown in FIG. 3, respectively engaged through the cam tracks 170. In the exemplary embodiment shown in the figures, each carriage 13, 14 includes a fixing plate 132, 142 comprising two parallel facing walls, between which a follower 131, 141 extends, each follower 131 and 141 being fixed by each of its ends to one of the walls. Thus, the cam 17 is always disposed in the space formed between the walls of each plate 132, 142, as can be seen in FIGS. 1 and 2.

The transmission shaft 18 is pivotally mounted in a first flange 120 of the frame 12 described in more detail below, on either side of which are arranged the plates 132, 142.

Advantageously, the device 10 can include a module for adjusting the angular position of the control element 16 relative to the frame 12 about the direction Y. Such an adjustment module is shown in FIGS. 1, 2 and 4 and kinematically connects the control element 16 to the cam 17 in order to transmit to the carriages 13 and 14 the forces generated by the actuation of the control element 16 to cause their respective movements.

In particular, the module for adjusting the angular position of the control element 16 includes an indexing wheel 160 integral in rotation with the cam 17 via the transmission shaft 18, the latter being integral in rotation with the indexing wheel 160. The transmission shaft 18 and the indexing wheel 160 can be prevented from rotating by any appropriate means, such as a pin, a key or sections of complementary polygonal shapes between the transmission shaft 18 and an opening of the indexing wheel 160 through which it is engaged.

The module for adjusting the angular position of the control element 16 also includes an indexing element 161 adapted to cooperate with the indexing wheel 160 in one of several angular positions of the latter so as to secure the control element 16 and the indexing wheel 160 in rotation.

As shown in FIGS. 1 and 4, the indexing element 161 is fixed to the control element 16 and is adapted to be removably engaged in one of a plurality of peripheral holes in the indexing wheel 160, the holes being evenly distributed around the axis of rotation of said indexing wheel 160, that is to say about the direction Y. It is understood here that the greater the number of holes, the greater the number of different angular positions the control element 16 can occupy. In the present example, the indexing element 161 is formed by an indexing finger carried by an arm fixed to the control element 16 and arranged so as to be rotatable relative to the indexing wheel 160.

Advantageously, the device 10 can also include a module for adjusting the minimum distance between the two tool holders 130 and 140, configured so as to be able to modify the amplitude of the travel of each of the carriages 13 and 14.

In particular, as can be seen in FIG. 3, the module for adjusting the minimum distance between the two tool holders 130 and 140 includes two stops 133 and 143 each arranged between one of the tool holders 130 and 140 and the fitting 11, and a positioning shaft 21 to which an operating member 22 is fixed. The positioning shaft 21 cooperates by helical connection with each of the stops 133 and 143 by means of threaded portions of opposite directions. In this way, the stops 133 and 143 can be moved in opposite directions when the operating member 22 is actuated. In the exemplary embodiment of the invention shown in the figures, the positioning shaft 21 is engaged so that it can rotate through a second flange 121 of the frame 12 substantially parallel to the first flange 120.

As shown in FIGS. 1 to 4, the operating member 22 includes a knurling-roller fixed to one end of the positioning shaft 21. The operating member 22 may also include an adjustment nut 220 constituting a stop for the knurling-roller in order to secure the position of the stops 133 and 143 while allowing its fine adjustment. Such an adjustment nut 220 is freely rotatably engaged on the positioning shaft 21 and cooperates with the second flange 121 by a helical connection.

As can be deduced from the above and from the figures, the module for adjusting the minimum distance between the two tool holders 130 and 140 allows to modify the position of an end of travel of the control element 16.

The first and second flanges 120 and 121 are both fixed to a base 123 of the frame 12 carrying the entire device 10. They are also arranged on either side of the fitting 11 as can be deduced from the above text and as shown in the figures. The first and second flanges 120 and 121 include openings through which extend translational guide rods 134 provided to one of the carriages, referred to as the “first carriage” 13.

The tool holder 130 of the first carriage 13 is integral in translation with the guide rods 134. In the preferred exemplary embodiment of the invention, the guide rods 134 are arranged parallel to one another on either side of the fitting 11, so that the latter is interposed between said guide rods 134. This arrangement enables the forces concerned on the guide rods 134 to be distributed uniformly when a watch case is opened.

Advantageously, the plate 132 of the first carriage 13 fixedly connects, that is to say without any degree of freedom, the two guide rods 134 at one of their free ends, as shown in FIGS. 2 to 4.

In the example shown in the figures, the second carriage 14 is configured so that it can be slidably guided by the guide rods 134. Thus, the design of the device 10 is simplified and relatively robust.

Preferably, at least one of the first or second carriages 13 or 14 includes, at its tool holder 130 or 140, a module for adjusting the position of the knife that it carries. More specifically, the adjustment module is configured to move the knife relative to the first or second carriage 13 or 14 in at least one direction parallel to the direction X.

As can be seen in FIG. 3, the adjustment module may include a slide 150 comprising a housing designed to receive the knife, and an adjustment screw 151 capable of acting on the slide 150 so as to move it towards or away from the fitting 11.

In the preferred exemplary embodiment of the invention, the fitting 11 comprises a module for adjusting its linear position configured to drive the fitting 11 in translation in a direction Z orthogonal to the direction X as shown in FIG. 1.

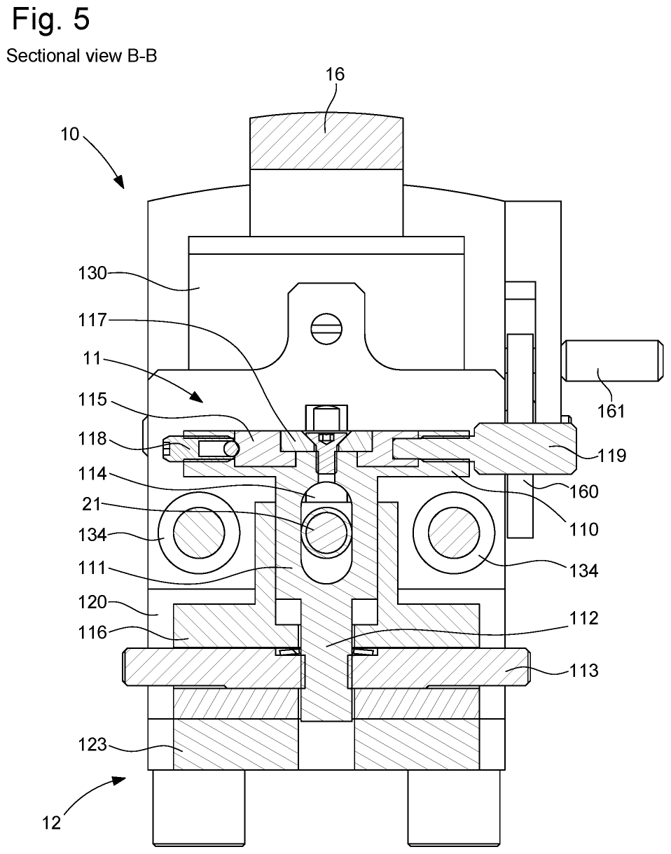

In particular, the module for adjusting the linear position of the fitting 11 is formed by a fitting body arranged so as to be movable in translation in a structure 116 of the fitting 11. As shown in the sectional views of FIGS. 3 and 5, the fitting body includes a support 110 designed to hold the case in position, connected to a guide portion 111 fitted with a degree of freedom in translation in a tubular part of the structure 116 of the fitting 11.

The guide portion 111 is extended by a threaded portion 112 cooperating with an operating member 113 in a helical connection, either directly or indirectly. In the preferred embodiment of the invention, the threaded portion 112 cooperates directly with a thread of a wheel, for example splined around its periphery to facilitate handling.

Advantageously, as can be seen in FIGS. 3 and 5, the guide portion 111 has a through hole 114, preferably oblong in shape, through which the positioning shaft 21 of the module for adjusting the minimum distance between the two tool holders 130 and 140 extends. It is understood here that the positioning shaft 21 extends at each of the ends of the through hole 114 when the fitting 11 occupies either of its extreme linear positions.

Advantageously, the fitting 11 can be movable in rotation about the direction Z and can comprise a module for adjusting its angular position. This adjustment module is configured so as to release the fitting 11 in rotation about the direction Z or to immobilise the fitting 11 in rotation. In particular, the module for adjusting the angular position of the fitting 11 is able to authorise rotation of the fitting 11 in any angular position that it may occupy.

To this end, in the preferred exemplary embodiment shown in the figures, the module for adjusting the angular position of the fitting 11 includes a ring 115, having a form of revolution, housed in a cavity of the fitting 11, and in particular of the support 110, so that the axis of revolution of the ring 115 coincides with the direction Z. The ring 115 is designed to receive the watch case and hold it in position by means of pins, for example. The ring 115 is immobilised in translation by a blocking element fixed to the support 110. More specifically, as shown in FIGS. 3 and 5, the ring 115 includes a central opening wherein a stud of the support 110 extending in the direction Z, is engaged. The blocking element can be formed by a washer 117 fixed to the central stud by a screw so as to cover part of the ring 115. More particularly, in the example shown in the figures, the washer 117 extends radially beyond the stud so as to cover an inner peripheral lip of the ring 115. In other words, the ring 115 includes an inner peripheral lip forming a shoulder with which the washer 117 cooperates to prevent the ring 115 from moving in translation.

The module for adjusting the angular position of the fitting 11 may include a rotation blocking element capable of allowing or blocking the rotation of the ring 115 about the direction Z. This blocking element is preferably formed by an indexing member 119 designed to block the fitting 11 in at least one predetermined angular position, referred to as the “reference position”. More specifically, the indexing member 119 can be in the form of a finger movable in translation between a position shown in FIG. 5, wherein it is engaged in a radial hole of the support 110 and in a radial hole of the ring 115, and wherein it prevents rotation of the ring 115 relative to the support 110, and a release position wherein it is withdrawn from the radial hole of the ring 115 and wherein, therefore, it releases the rotation of the ring 115. The indexing member 119 can be constrained in the position of engagement in the radial hole of the ring 115 by an elastic member (not shown in the figures).

Advantageously, the module for adjusting the angular position of the fitting 11 may include an elastic positioning member 118 fixed to the fitting 11, in particular to the support 110, intended to work in compression and intended to cooperate with a cavity of the ring 115 so as to provide an indication to a user when the ring 115 reaches the reference angular position. More specifically, the elastic positioning member 118 may be formed by a ball spring pad. During rotation of the ring 115 about the direction Z, once the ring 115 reaches the reference position, the elastic positioning member 118 cooperates with the cavity of said ring 115 which, on the one hand, causes haptic feedback for a user, and on the other hand, requires overcoming a resistance to remove the elastic positioning member 118 from the cavity of said ring 115 in order to continue the rotation of said ring 115.

Once the reference position has been identified, the ring 115 can be locked in this position by the indexing member 119.

Thus, the fitting 11 can adopt a predefined angular position quickly and easily, while being guaranteed to remain immobilised in this position.

More generally, it should be noted that the implementations and embodiments considered above have been described by way of non-limiting examples, and that other variants are therefore conceivable.

1. A device for opening a watch case including a back fixed to a middle by interlocking, wherein the device comprises a fitting fixed to a frame and intended to hold a watch case in position, at least one carriage movable in translation relative to the frame in a direction X, the carriage including a tool holder to which a knife is fixed, the device further includes a control element designed to be actuated by a user, kinematically connected to the carriage with a transmission member configured so that when the control element is actuated, the carriage is translated towards the fitting or in a direction opposite to the fitting.

2. The device according to claim 1, comprising two carriages movable in translation with respect to the frame in the direction X, on either side of the fitting, the transmission member being configured so that when the control element is actuated, the carriages are translated in opposite directions.

3. The device according to claim 2, comprising a module for adjusting the minimum distance between the two tool holders, configured so as to be able to modify the amplitude of the stroke of each of the carriages.

4. The device according to claim 3, wherein the module for adjusting the minimum distance between the two tool holders includes two stops each arranged between one of the tool holders and the fitting, and a positioning shaft to which an operating member is fixed, said positioning shaft cooperating by helical connection with each of the stops with threaded portions of opposite directions.

5. The device according to claim 1, wherein the fitting comprises a module for adjusting its linear position configured to drive the fitting in translation in a direction Z orthogonal to the direction X.

6. The device according to claim 5, wherein the module for adjusting the linear position of the fitting is formed by a fitting body arranged so as to be movable in translation in a structure of the fitting, the fitting body including a threaded portion cooperating with an operating member in a helical connection.

7. The device according to claim 1, wherein the fitting can be rotated about a direction Z orthogonal to the direction X and comprises a module for adjusting its angular position configured so as to release the fitting in rotation about the direction Z or to immobilise the fitting in rotation.

8. The device according to claim 7, wherein the module for adjusting the angular position of the fitting includes an indexing member adapted to block the fitting in a reference angular position.

9. The device according to claim 7, wherein the module for adjusting the angular position of the fitting includes a ring housed in a cavity of the fitting, said ring being intended to hold the watch case in position and being movable in translation about the direction Z and being immobilised in translation by a blocking element.

10. The device according to claim 9, wherein the module for adjusting the angular position of the fitting includes an elastic positioning member fixed to the fitting, designed to work in compression and designed to cooperate with a cavity of the ring when the ring reaches the reference angular position.

11. The device according to claim 1, wherein the carriage comprises a module for adjusting the position of the knife which it carries, said adjustment module being configured to move the knife relative to the carriage in at least one direction parallel to direction X.

12. The device according to claim 2, wherein the transmission member includes a cam integral in rotation with the control element, said cam comprising two cam tracks with each of which a follower cooperates, said followers being fixed respectively to each of the carriages.

13. The device according to claim 12, wherein the two cam tracks are symmetrical to each other with a symmetry whose centre is aligned with the axis of rotation of the cam.

14. The device according to claim 1, comprising a module for adjusting the angular position of the control element relative to the frame about a direction Y orthogonal to the direction X.

15. The device according to claim 12, comprising a module for adjusting the angular position of the control element relative to the frame about a direction Y orthogonal to the direction X, the cam being kinematically connected to the control element via the module for adjusting the angular position of the control element.

16. The device according to claim 15, wherein the module for adjusting the angular position of the control element includes an indexing wheel integral in rotation with the cam and an indexing element adapted to cooperate with the indexing wheel in one of several angular positions so as to make the control element and the indexing wheel integral in rotation.

17. The device according to claim 2, wherein the frame includes comprises two flanges arranged on either side of the fitting, said flanges including openings through which extend translational guide rods included in one of the carriages, referred to as the “first carriage”, the tool holder of the first carriage being integral in translation with the guide rods.

18. The device according to claim 17, wherein one of the carriages, referred to as the “second carriage”, is configured so as to be slidably guided by the guide rods.
